(19) United States
(12) Patent Application Publication
(10) Pub. No.: US 2017/0242245 A1
(43) Pub. Date: Aug. 24, 2017

(54) Head-up Display

(71) Applicant: Megaforce Company Limited, New Taipei City (TW)

(72) Inventor: Wei-Hsuan Chen, New Taipei City (TW)

(21) Appl. No.: 15/262,108

(22) Filed: Sep. 12, 2016

(30) Foreign Application Priority Data
Feb. 24, 2016 (TW) 105105559
Feb. 24, 2016 (TW) 105202614

(51) Int. Cl. G02B 27/01; G02B 5/02

(52) U.S. Cl. CPC G02B 27/0101; G02B 5/0284; G02B 2027/0118; G02B 2207/123; G02B 2027/0141

(57) ABSTRACT

A head-up display includes a laser projector, a diffuser, an image combiner, and a light shield. The laser projector emits an image beam. The diffuser has a reflection surface for receiving and diffusely reflecting the image beam emitted from the laser projector. The image combiner receives the image beam reflected from the diffuser to form a virtual image whereby a user sees the virtual image and a real-world environment at the same side of the virtual image through the image combiner. The light shield includes a grating structure disposed on the reflection surface of the diffuser.

### BACKGROUND OF THE INVENTION

1. Field of the Invention

The present invention relates to a head-up display and, more particularly, to a reflective head-up display.

2. Description of the Prior Art

A conventional head-up display, for example, as disclosed in U.S. Pat. No. 7,990,620 may generate a virtual image. However, stronger ambient light results in a reduced contrast ratio or luminance ratio of the virtual image.

### SUMMARY OF THE INVENTION

The present invention is adapted to providing a head-up display which may reduce the effect of ambient light on a contrast ratio of its generated virtual image.

According to an aspect of the present invention, there is provided a head-up display including a laser projector, a diffuser, an image combiner, and a light shield. The laser projector emits an image beam. The diffuser has a reflection surface for receiving and diffusely reflecting the image beam emitted from the laser projector. The image combiner receives the image beam reflected from the diffuser to form a virtual image whereby a user sees the virtual image and a real-world environment at the same side of the virtual image through the image combiner. The light shield includes a grating structure disposed on the reflection surface of the diffuser.

These and other objectives of the present invention will no doubt become obvious to those of ordinary skill in the art after reading the following detailed description of the preferred embodiment that is illustrated in the various drawings.

### BRIEF DESCRIPTION OF THE DRAWINGS

FIG. 1 is a schematic view of a head-up display according to an embodiment of the present invention;

FIG. 2 is a schematic view of a head-up display according to another embodiment of the present invention; and

FIG. 3 is a schematic view of a light shield according to an embodiment of the present invention.

### DESCRIPTION OF THE PREFERRED EMBODIMENTS

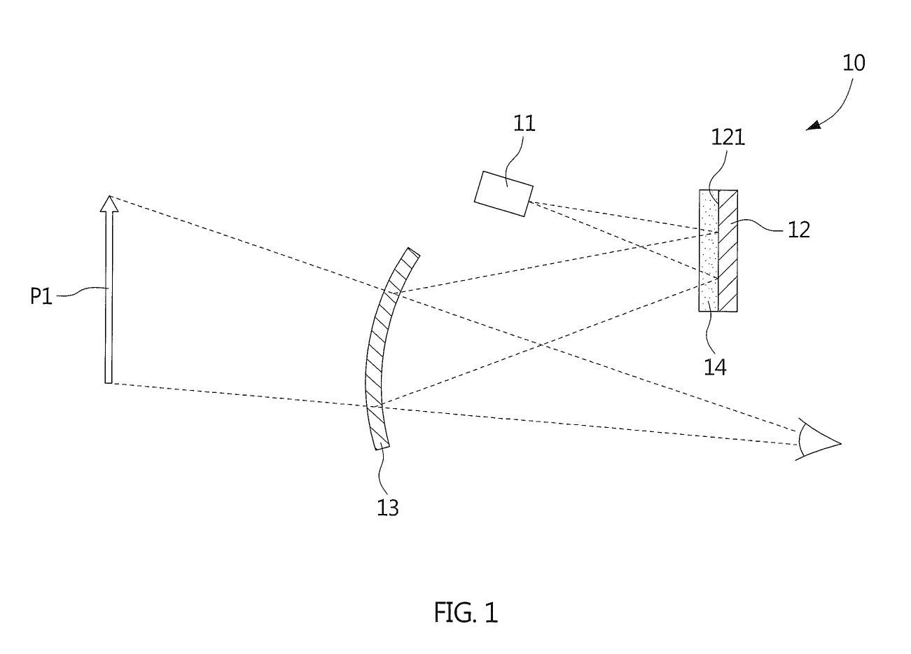

Referring to FIG. 1, there is shown a schematic view of a head-up display 10 according to an embodiment of the present invention. The head-up display 10 includes a laser projector 11, a diffuser 12, an image combiner 13, and a light shield 14. The laser projector 11 emits an image beam. The diffuser 12 has a reflection surface 121 for receiving and diffusely reflecting the image beam emitted from the laser projector 11. The image combiner 13 receives the image beam reflected from the diffuser 12 to form a virtual image P1 whereby a user may see the virtual image P1 and a real-world environment (not shown) at the same side of the virtual image P1 through the image combiner 13. The light shield 14 includes a grating structure (not shown) disposed on the reflection surface 121 of the diffuser 12. The grating structure may stop large-angle ambient light from entering the image combiner 13 by the reflection of the diffuser 12 so that it may reduce the effect of the ambient light on a contrast ratio of the virtual image P1.

In the embodiment, the diffuser 12 may be a white plastic sheet, and the light shield 14 may be a microlouver film. In the embodiment, the head-up display 10 may be used in a vehicle to display images about traffic information, and may be integrated into a device disposed in the top and front of the vehicle.

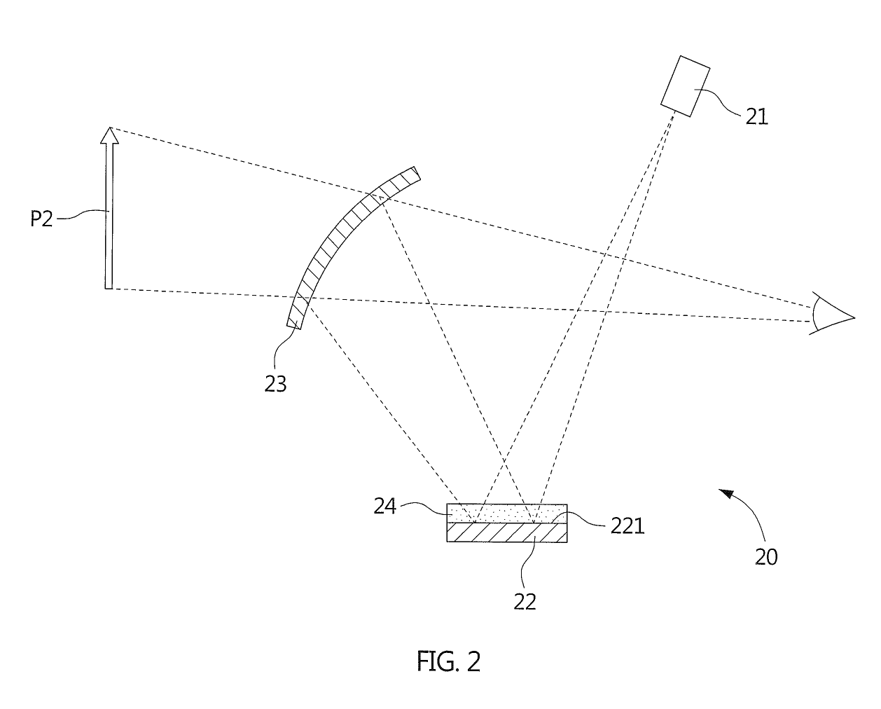

Referring to FIG. 2, there is shown a schematic view of a head-up display 20 according to another embodiment of the present invention. The head-up display 20 includes a laser projector 21, a diffuser 22, an image combiner 23, and a light shield 24. The laser projector 21 emits an image beam. The diffuser 22 has a reflection surface 221 for receiving and diffusely reflecting the image beam emitted from the laser projector 21. The image combiner 23 receives the image beam reflected from the diffuser 22 to form a virtual image P2 whereby a user may see the virtual image P2 and a real-world environment (not shown) at the same side of the virtual image P2 through the image combiner 23. The light shield 24 includes a grating structure (not shown) disposed on the reflection surface 221 of the diffuser 22. The grating structure may stop large-angle ambient light from entering the image combiner 23 by the reflection of the diffuser 22 so that it may reduce the effect of the ambient light on a contrast ratio of the virtual image P2.

In the embodiment, the diffuser 22 may be a white plastic sheet, and the light shield 24 may be a microlouver film. In the embodiment, the head-up display 20 may be used in a vehicle to display images about traffic information, and may be generally disposed in a discrete arrangement in the vehicle. For example, the laser projector 21 may be disposed in the top and front of the vehicle, the diffuser 22 and the light shield 24 may be disposed on the dashboard below the windshield, and the image combiner 23 may be disposed on the windshield.

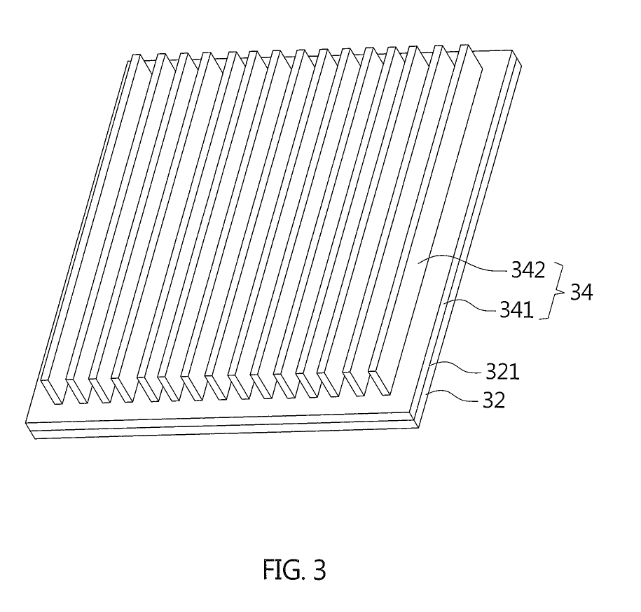

Referring to FIG. 3, there is shown a schematic view of a light shield 34 according to an embodiment of the present invention. The light shield 34 includes a transparent sheet 341 and an opaque grating structure 342. The grating structure 342 is disposed on the transparent sheet 341. The transparent sheet 341 is disposed on the reflection surface 321 of the diffuser 32.

It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. A head-up display comprising:
a laser projector for emitting an image beam;
a diffuser having a reflection surface for receiving and diffusely reflecting the image beam emitted from the laser projector;
an image combiner for receiving the image beam reflected from the diffuser to form a virtual image whereby a user sees the virtual image and a real-world environment at the same side of the virtual image through the image combiner; and
a light shield comprising a grating structure disposed on the reflection surface of the diffuser.

2. The head-up display of claim 1, wherein the light shield further comprises a transparent sheet disposed on the reflection surface of the diffuser.

3. The head-up display of claim 2, wherein the grating structure is disposed on the transparent sheet.
